(19) United States
(12) Patent Application Publication
(10) Pub. No.: US 2017/0061386 A1
(43) Pub. Date: Mar. 2, 2017

(54) Automated Negotiator for Scheduling

(71) Applicants: Nicholas T. Haynes, Seattle, WA (US); Kiley F. Williams, Chicago, IL (US); David L. Young, Stillwater, MN (US)

(72) Inventors: Nicholas T. Haynes, Seattle, WA (US); Kiley F. Williams, Chicago, IL (US); David L. Young, Stillwater, MN (US)

(21) Appl. No.: 14/835,778

(22) Filed: Aug. 26, 2015

(51) Int. Cl. G06Q 10/10

(52) U.S. Cl. CPC G06Q 10/1095

(57) ABSTRACT

A scheduling system may automatically negotiate with recipients to find important conditions or constraints regarding a proposal. The system may use phone, text, email, social media, or other communications tools to propose something to one or more users, and if a user does not like the proposal, take feedback or proposed changes from the user in a fully automated manner. The proposed changes may be approved or other changes proposed and re-communicated with the users. The system may include a user interface for creating and managing proposals, as well as a user interface for communicating proposals and gathering feedback in an automated manner.

### BACKGROUND

Scheduling a meeting or event is a classic case of negotiating. An event organizer may invite a handful of friends for lunch, for example, and each person may have different conflicts or constraints about the specific time, place, or other factors about the lunch. The organizer may send out requests to the friends, who may confirm the original time and place, while other friends may suggest changes, such as starting earlier or later, or suggesting a different location for a variety of reasons.

As the group interacts, the organizer may adjust the time and place to accommodate one friend, but that may adversely affect another friend who already confirmed. This process may iterate several times, resulting in a very frustrating and time-consuming experience for everyone involved.

### SUMMARY

A scheduling system may automatically negotiate with recipients to find important conditions or constraints regarding a proposal. The system may use phone, text, email, social media, or other communications tools to propose something to one or more users, and if a user does not like the proposal, take feedback or proposed changes from the user in a fully automated manner. The proposed changes may be approved or other changes proposed and re-communicated with the users. The system may include a user interface for creating and managing proposals, as well as a user interface for communicating proposals and gathering feedback in an automated manner.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a scheduling manager with an automated negotiator.

FIG. 2 is a diagram illustration of an embodiment showing a network environment with an automated negotiator for scheduling.

FIG. 3 is a diagram illustration of an embodiment showing an overall process for negotiating schedules.

FIG. 4 is a diagram illustration of an embodiment showing a sample dialog between an automated negotiator and an attendee.

FIG. 5 is a flowchart illustration of an embodiment showing a method for setting up an event.

FIG. 6 is a flowchart illustration of an embodiment showing a method for adding attendees to an event.

FIG. 7 is a flowchart illustration of an embodiment showing a method for automated negotiation of a scheduled event.

### DETAILED DESCRIPTION

Automated Negotiator

An automated negotiator may send notices about an offer and collect replies, which may include proposed changes to the notice. The automated negotiator may communicate with a user using text messaging, electronic mail, social media communications, or other mechanism, including automated voice systems provided over a telephone or other voice system.

In a typical scenario with a scheduling system, an event organizer may propose a meeting with a set of users. The automated negotiator may notify each of the users and may solicit a response. The response may be an acceptance or rejection. When a rejection may be received, the automated negotiator may solicit a reason for the rejection. The automated negotiator may also solicit proposed changes to the offer. The proposed changes may be relayed to the event organizer, or may be accepted or rejected automatically based on predefined conditions for the event.

The automated negotiator may serve as a convenient and efficient way to collect feedback and counter proposals from recipients of an offer. The system may operate automatically, thereby unburdening the person who created and manages the offer. In some cases, the automated negotiator may have a set of rules defined for an offer, such that the automated negotiator may be able to confirm a counter proposal or make a further counter offer. When both parties agree, the offer may be confirmed. In the example of a scheduling negotiator, an event may be added to the two user's schedules and confirmed.

Scheduling Manager

A scheduling manager may operate with an automated negotiator to create and manage events with multiple attendees. The scheduling manager may have a management user interface from which an event organizer may define an event and one or more attendees. The attendees may be notified using an automated negotiator, which may communicate with and solicit feedback from the attendees.

Some attendees may have shared calendar information with the scheduling manager. In such cases, the automated negotiator may examine an attendee's schedule and determine that the attendee may be able to attend. The automated negotiator may still communicate with the attendee to determine whether or not the attendee wishes to attend. In cases where the attendee has other items scheduled, the automated negotiator may communicate with the attendee and may receive feedback or suggested changes to make for the event.

Other attendees may not have shared calendar information with the scheduling manager. Such attendees may be identified by a telephone number, email address, social media contact information, or other identifier. The scheduling manager may create a temporary or internal schedule for the individual, and may use the automated negotiator to determine whether the attendee is busy or free during that time, and whether or not the attendee will attend. The automated negotiator may also collect proposed changes to the event and relay the information to the event organizer.

Any feedback from the attendees may be forwarded to the event organizer, who may accept, reject, or propose further changes to the event. The feedback may be monitored and tracked, and may be further used to analyze behavior of people in the system.

The behavior profiles may be used to anticipate a user's behavior for future events. For example, a certain user may continually reject offers to attend a meeting by another user. Such a situation may cause the automated negotiator to try different ways of communicating with the user as well as to predict the user's attendance at the time a new event that may be created that is similar to previous events.

The scheduling system may be able to schedule sophisticated and complicated scheduling tasks. For example, a meeting with a large group of people may be automatically negotiated on an iterative basis to find the best fit of a meeting for all of the various participants. The attendees may only answer a few short text messages, have a short chat with an automated, voice-activated, telephone system, answer a short email exchange, or quickly enter data on a webpage. From the interaction, a scheduling system may schedule a meeting given all of the attendee's constraints.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

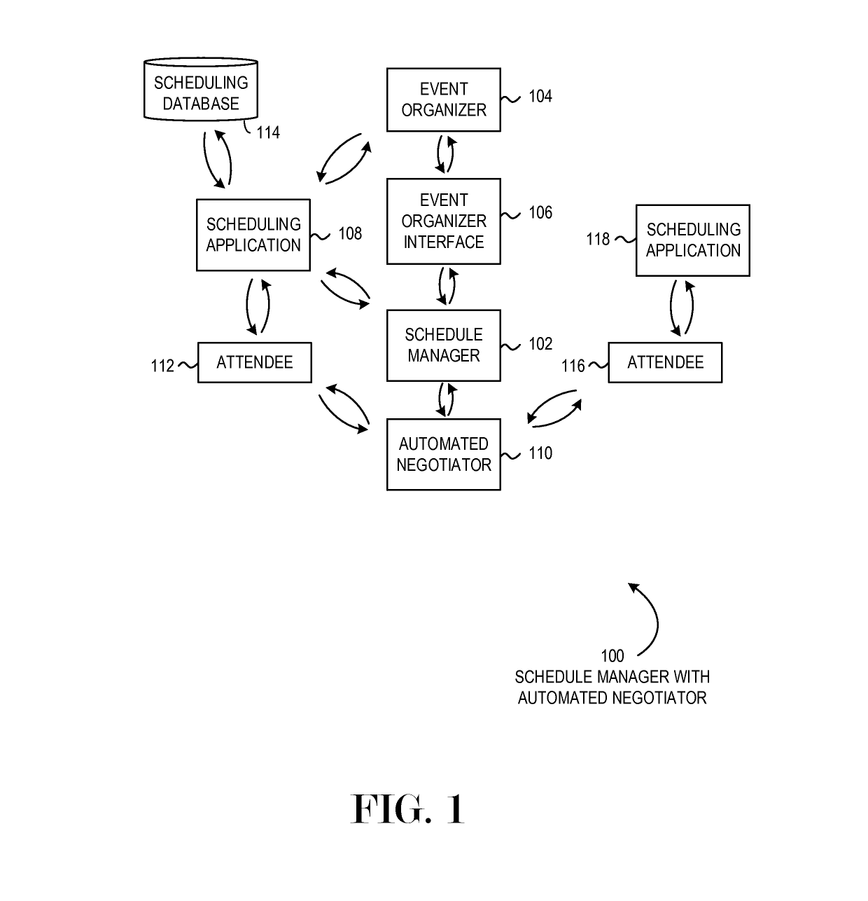

FIG. 1 is a diagram illustration of an embodiment 100 showing a schedule manager with an automated negotiator. Embodiment 100 is merely one example of functional components that may interact to provide a scheduling negotiator for event attendees both inside and outside a scheduling system.

A scheduling system may handle day to day activities of managing user schedules. These activities may include adding, modifying, and other management activities for individual events, as well as reminding users of upcoming events and scheduling meetings with multiple people. In many cases, a scheduling system may interface with various applications, including mobile phone applications, desktop applications, and other applications so that a user may interact with their schedule through different interfaces.

An event organizer 104 may use an event organizer interface 106 to schedule an event with other users. In some cases, the event may be a simple meeting, such as scheduling a coffee meeting, and in other cases, the event may involve multiple people, such as a business team meeting or a practice session for a recreational athletic team.

An event may be any schedule item that involves two or more users. Many events may have a specific time and date when the event may occur, and in some cases, events may have locations. Some events, such as a meeting via telephone or video conferencing, may not have a location.

The event organizer interface 106 may be any user experience through which an event organizer may set up, edit, and manage an event. In a typical use scenario, an event organizer may set up details of an event, invite attendees, and may make changes to the event parameters based on feedback from other attendees.

The attendees 112 and 116 may fall into two main categories. Attendee 112 may represent a user who may share the same scheduling application 108 as the event organizer 104. Attendee 116 may use a separate, third party scheduling application 118.

When attendees 112 share the same scheduling application 108 as the event organizer 104, a schedule manager 102 may be able to determine an attendee's possible availability for a proposed event. For attendees 116, the scheduling manager 102 may not have access to the attendee's calendar so fewer inferences may be made regarding that attendee's availability.

An event organizer 104 may have the option of soliciting feedback from attendees. The feedback may be more detailed than purely accept or reject, and may include suggestions for alternatives as well as parameters and priorities for deciding between alternatives.

An automated negotiator 110 may handle the interactions with various attendees. The automated negotiator 110 may have an interactive component that may converse with an attendee to determine alternatives, and in some cases, the automated negotiator 110 may be able to determine priorities or decision parameters that may affect the attendee's schedule.

The automated negotiator 110 may collect information from potential attendees, and may also converse with the event organizer 104 to gather additional information or to reach a decision. Once the information has been gathered from all parties, a final determination may be made and the event may be scheduled on each attendee's calendars.

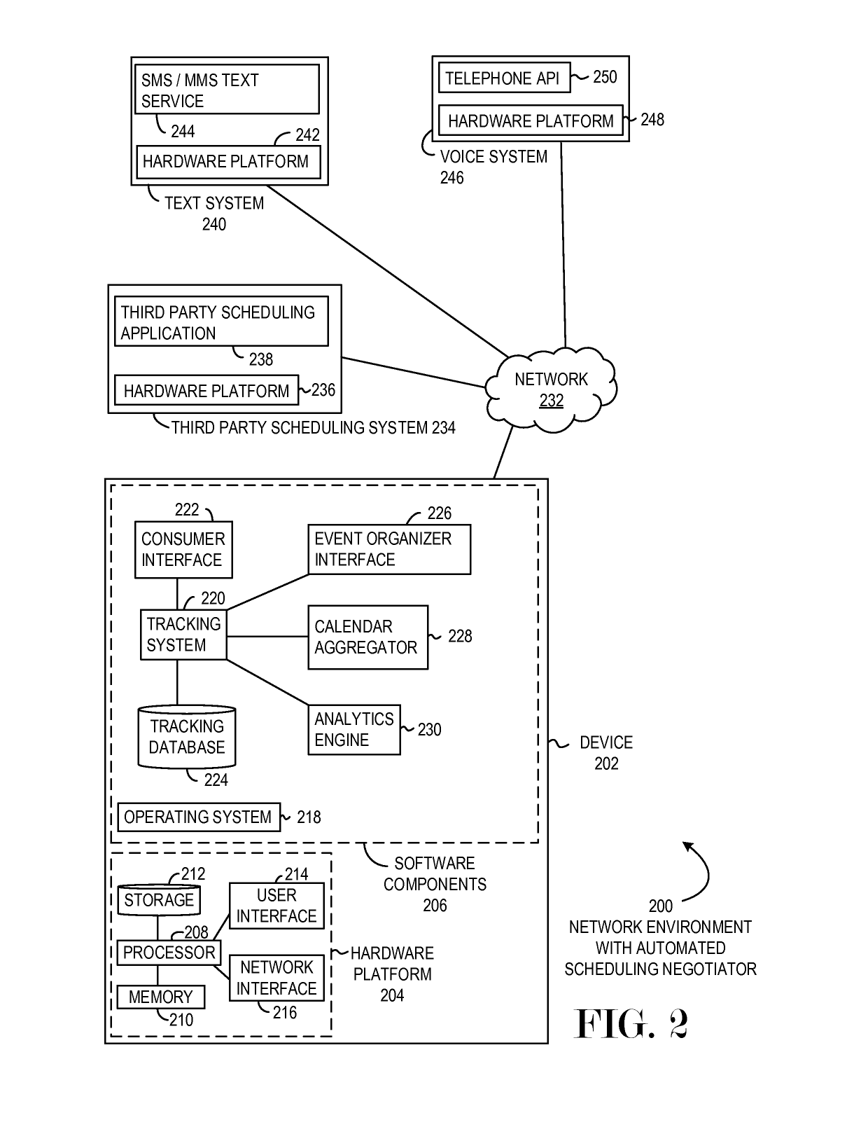

FIG. 2 is a diagram of an embodiment 200 showing components that may manage schedules with an automated negotiator.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A scheduling application 220 may manage users' schedules through various user interfaces 222 by maintaining events in a schedule database 224. A user may be able to create and delete events, edit events, share events with others, and otherwise interact and manage their schedules. Many systems may have multiple user interfaces. For example, a scheduling system may have a website interface, desktop application, mobile device interface, and other interface. In some cases, a scheduling application 220 may have an application programming interface 230 as well.

One part of a scheduling application 220 may include an event organizer interface 226. In some cases, the event organizer interface 226 may be a dedicated interface for scheduling events, although in other cases the event organizer interface 226 may be various interface components that may be presented as a subset of other user interfaces.

The event organizer interface 226 may include mechanisms for identifying attendees for an event. An event may include a meeting start and stop time. Some events may include a location, as well as other parameters.

The event organizer interface 226 may also include various mechanisms through which an event organizer may identify their flexibility on various parameters. The flexibility may be expressed as priorities, limits, preferences, or other expressions that may be used to negotiate changes to the event.

An automated negotiator 228 may contact the various attendees to determine whether the initial event parameters are acceptable, as well as gather suggested changes to the event. In many cases, an automated negotiator 228 may attempt to gather an attendee's flexibility on various event parameters, and may suggest a solution that may meet the preferences of the event organizer as well as an attendee.

The automated negotiator 228 may operate in various modes. In one mode, the automated negotiator 228 may be able to collect suggested changes from attendees and present the feedback to an event organizer. The event organizer may then approve, reject, or suggest new changes. In another mode, the automated negotiator 228 may be capable of approving certain changes to an event without involving the event organizer.

The automated negotiator 228 may interact with attendees who have their schedules in the schedule database 224, as well as attendees who may use a third party scheduling application. Such attendees may use a third party scheduling system 234 which may be available over a network 232. A third party scheduling application 238 may operate on a hardware platform 236.

When the automated negotiator 228 interacts with attendees on a third party scheduling application 238, a schedule for that attendee may be built within the schedule database 224. An automated negotiator 228 may help identify events on the attendee's schedule, including free/busy times, and may populate a phantom schedule for the attendee. The phantom schedule may or may not be available for the attendee to view, modify, or use, and may be a representation of a portion of the attendee's schedule for performing an automated negotiation.

An automated negotiator 228 may use text messaging to communicate with potential attendees. A text system 240 may include a hardware platform 242 on which an SMS/MMS text service 244 may be accessed. The SMS/MMS text service 244 may transmit individual or group text messages using telephone or other protocols.

Similarly, a voice system 246 may be used in some cases to place a phone or voice call to an attendee. The voice system 246 may have a hardware platform 248 on which a voice or telephone application programming interface 250 may operate. The voice system may enable an automated negotiator 228 to generate spoken messages and to receive spoken responses.

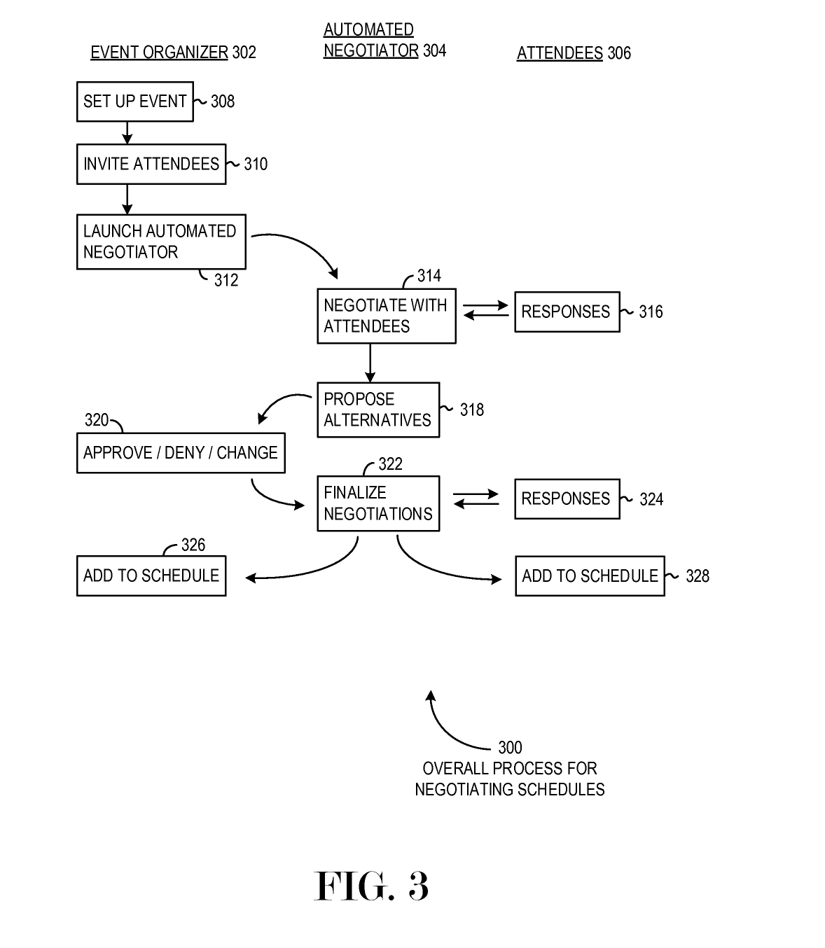

FIG. 3 is a flowchart illustration of an embodiment 300 showing a simplified example of interactions by an automated negotiator. Actions by an event organizer 302 may be illustrated in the left hand column, actions by the automated negotiator 304 may be illustrated in the center column, and actions by attendees 306 may be illustrated in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may illustrate an example interaction where an automated negotiator 304 may interact with attendees 306, then propose alternatives to an event organizer 302, who may finalize an event.

A typical use case may be for an event organizer to schedule an activity with a group of friends. For example, an organizer may want to schedule a weekend brunch meeting at a restaurant with five friends.

The event organizer 302 may set up the event in block 308 and invite attendees in block 310. The automated negotiator may be launched in block 312.

The automated negotiator 304 may negotiate with attendees in block 314, and the attendees 306 may send responses in block 316.

In some cases, the automated negotiator 304 may be empowered to finalize a decision automatically. Typically, such a situation may occur when the event organizer creates negotiable parameters that are express or implied, and the attendees agree to an event within the parameters.

In the example of bunch with friends, an event organizer may suggest a time and location, but may be comfortable having the event up to two hours before or one hour after the original time, and may prefer one restaurant but would also consider any restaurant within a ten-mile radius. During the negotiation phase, an attendee may request an earlier start time which may be inside or outside the scope of the organizer's preferences. Another attendee may suggest a different location, which again may be inside or outside the scope of the organizer's preferences.

After negotiating with the attendees in block 314, the automated negotiator 304 may propose alternatives in block 318, which may be approved, denied, or changed by the event organizer 302 in block 320. The automated negotiator 304 may finalize the negotiations in block 322 and solicit further responses in block 324 from the attendees 306. After finalizing the negotiations in block 322, the event may be added to the event organizer's schedule in block 326 and to the attendees schedule in block 328.

In our example of scheduling brunch, an event organizer may be faced with a decision as to whether to go ahead with a time and location that may be unfavorable or impossible for one of the attendees to make. In such a case, the event organizer may override an attendee's suggestion even though it may mean that the attendee may not be able to attend.

Such a situation may illustrate another parameter that may be negotiated, which is the attendee list. In some cases, an event organizer may identify a priority of attendees, such that some attendee's suggested changes may be given higher weight than others when automatically determining a negotiated solution.

In some cases, an automated negotiator may be able to approve a change suggestion by an attendee without consulting the event organizer. Such an approval may be made using the event organizer's preferences and acceptable alternatives. In cases where an event may be scheduled between an organizer and one attendee, such an approval may be final. In other cases, such as where multiple attendees might be simultaneously negotiating about an event, such approval may be tentative and subject to further verification or approval.

The example of embodiment 300 may illustrate a simple example with one set of negotiations and a finalization of the negotiations. In some cases, the negotiations may iterate multiple times between the attendees and the event organizer.

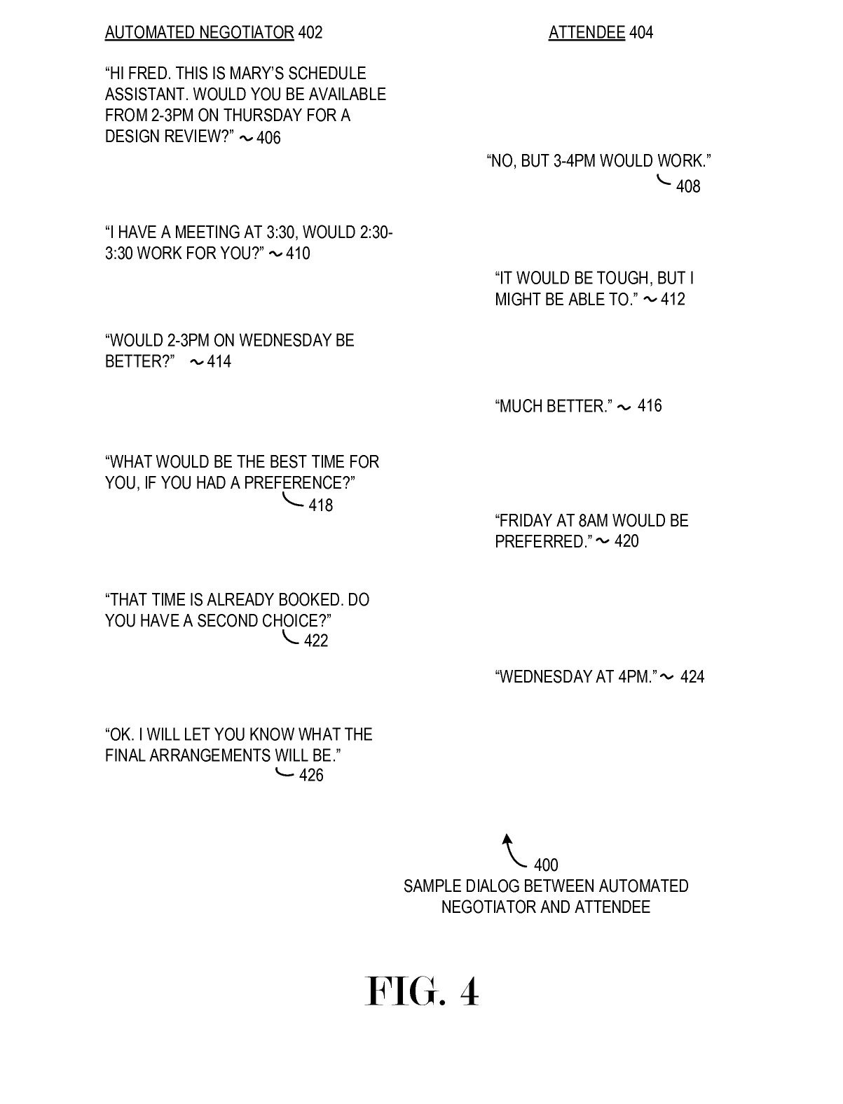

FIG. 4 is a diagram illustration of an embodiment 400 showing a sample dialog between an automated negotiator and an attendee. The sample dialog may be performed through text messaging, voice communications, electronic mail, or other mechanisms. The dialog of the automated negotiator 402 may be shown in the left hand column and the responses of the attendee 404 may be shown in the right hand column.

The sample dialog may illustrate the initial proposal of an event, gather the attendee's response, and collect some information regarding alternatives.

The automated negotiator 402 may ask “Hi Fred. This is Mary's schedule assistant. Would you be available from 2-3 pm on Thursday for a design review?” in block 406. The attendee 404 may reply in block 408 saying “No, but 3-4 pm would work.”

In this exchange, the attendee may reject the original offer and give a counter-offer or proposal. The automated negotiator 402 may check the event organizer's schedule and may reply in block 410 saying “I have a meeting at 3:30. Would 2:30-3:30 work for you?” The attendee 404 may reply with “It would be tough, but I might be able to” in block 412.

The attendee's response in block 412 may indicate that the negotiator's counter-offer of 2:30-3:30 would not be ideal for the attendee. In response, the automated negotiator 402 may reply with another proposal, saying “Would 2-3 pm on Wednesday be better?” in block 414, to which the attendee 404 may reply “Much better” in block 416. Such a response may indicate a more preferred option for the attendee.

The automated negotiator 402 may attempt to gather some more of the attendee's preferences by asking in block 418 “What would be the best time for you, if you had a preference?” The attendee 404 may reply in block 420 with “Friday at 8 am would be preferred.” The automated negotiator 402 may look up that proposal to find that the event organizer is not available and may reply in block 422 with “That time is already booked. Do you have a second choice?” The attendee 404 may reply with “Wednesday at 4 pm” in block 424.

Having gathered several alternatives and preferences of the attendee through the questions, the automated negotiator 402 may finish the dialog with block 426 stating “Ok. I will let you know what the final arrangements will be.”

The interactions of embodiment 400 may be similar to those that may be made through text messaging or using an automated voice system. The back and forth of determining the attendee's schedule and finding out the best options for both parties may be largely handled by the automated negotiator 402, which may unburden the event organizer from the tedium of going back and forth with each attendee.

An automated negotiator may be useful in situations where multiple attendees are being scheduled. In such cases, each attendee may have different constraints on their schedule, which may be hard constraints that cannot be changed, as well as soft constraints that may be preferences that may altered.

The interactions of embodiment 400 may illustrate how an automated negotiator may gather preferences of an attendee. The preferences may be used to generate proposals for the event organizer to approve or suggest alternatives. In cases where the proposal may be outside of a range of possible values, the automated negotiator may tell the attendee that the proposal may not work, and may continue to collect possible alternatives.

When the interactions of embodiment 400 may be performed with an attendee who may not have a calendar in a scheduling system, a phantom calendar may be created for the attendee within the system. The phantom calendar may be populated with the attendee's availability and preferences, and the phantom calendar may be combined with other attendee's calendars in the scheduling system to determine alternatives for an event.

The interactions of embodiment 400 may have a conversational tone. The messages may be tailored to specific demographics, locations, or situations. For example, a casual meeting of friends may be negotiated with a less formal set of interactions than a high level business meeting between different companies.

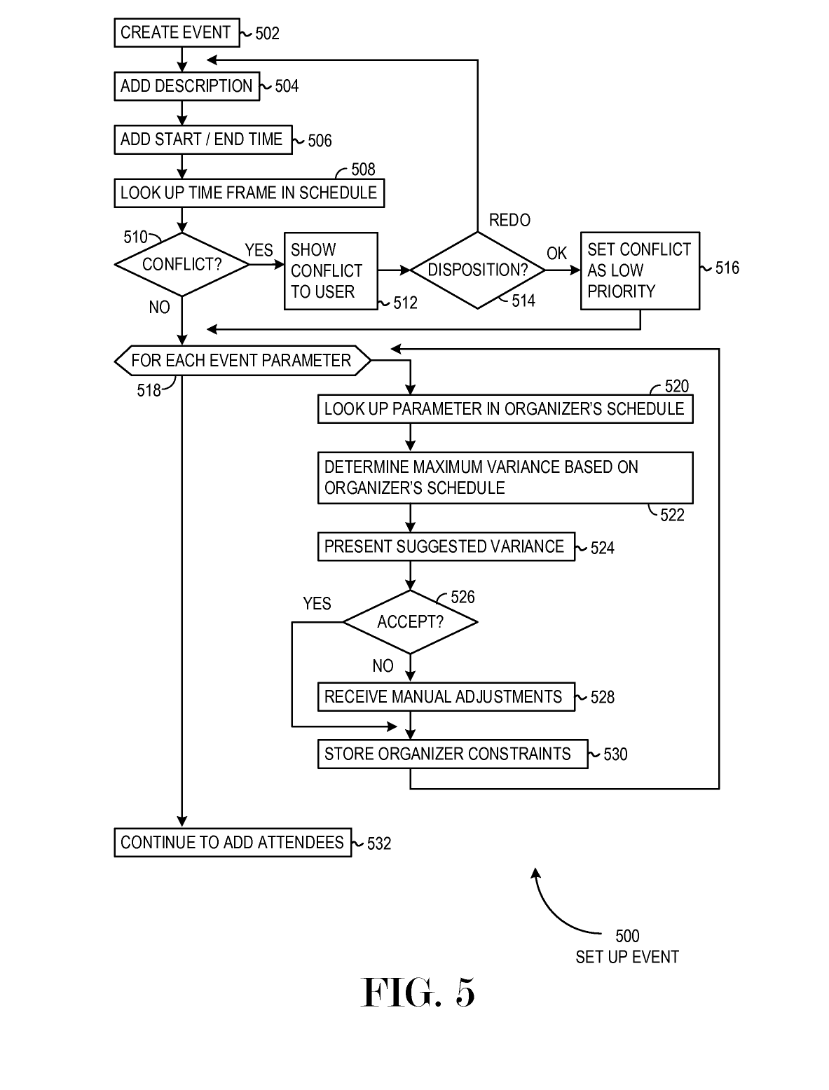

FIG. 5 is a flowchart illustration of an embodiment 500 showing a simplified example of steps that may be performed to set up an event. Embodiment 500 may include setting up the basic parameters of an event, as well as determining a priority, variance, acceptable limit, or other information about the parameter.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 may illustrate a mechanism to gather event information from an event organizer. The event information may include parameters defining the event, as well as the event organizer's flexibility for each of the parameters. The flexibility may be used by an automated negotiator to automatically approve or reject a counter offer, or may be used to automatically negotiate options that may maximize the event organizer's priorities.

An event organizer's priorities may be determined by observing the event organizer's actions regarding previous events, analyzing the event organizer's schedule, and through direct input from the event organizer.

An event may be created in block 502 and a description may be added in block 504. The description may include a location, venue, conference room reservation, or other parameter, along with a textual description of the intended event. In some cases, such a description may include a short title as well as a long description that may include document attachments, website links, directions to a venue, or other information.

A start and end time may be identified in block 506. Based on the start and end time, a lookup may be performed against the event organizer's schedule in block 508 to determine if a conflict may be present in block 510. A conflict may be defined by overlapping times, unavailable venues, or other parameters that may be identifiable as a conflict.

If a conflict exists in block 510, the conflict may be presented to the event organizer in block 512. The event organizer may disposition the conflict in block 514 by redoing the description going back to block 504 or by setting the conflict as a low priority in block 516, which may ignore the conflict.

Each event parameter may be analyzed in block 518. The analysis may attempt to determine a tolerance, acceptable variance, options, or other alternatives for a given parameter. The alternatives may include rankings, priorities, or importance such that an automated negotiator may be able to determine whether a variance may be acceptable or not to an event organizer. In many cases, an automated negotiator may attempt to maximize the parameter values for one or both parties when finding a solution.

For each event parameter in block 518, the parameter may be looked up in the event organizer's schedule in block 520. A determination may be made in block 522 of a maximum variance based on the organizer's schedule. The suggested variance may be presented to the event organizer in block 524. The event organizer may accept the proposed variance in block 526, or may not accept the proposed variance in block 526 and may make a manual adjustment in block 528. The event organizer's constraints may be stored in block 530.

An example of an event parameter may be the time of an event. In one case, the event organizer may have meetings that may bookend the allocated time, so therefore changes to the start and end time may not be flexible. However, there may be alternative times or days that may be free for the event organizer. The system may identify those alternative times and may suggest one or more as alternative times.

Another example of an event parameter may be a location. From the event organizer's calendar, the system may determine locations where the event organizer may be before and after the proposed time, then may consider travel time when determining possible times for the event. For example, the earliest the event organizer may arrive at a restaurant across town may be determined by estimating the travel time from a previous event and adding the travel time to the estimated end time of a previous event.

In some cases, the previous behaviors of an event organizer may be used to estimate parameter variance. For example, a scheduling system may have a record of previous meetings where the event organizer repeatedly left a meeting late. Such information may be available from a scheduling system that may include location tracking systems or other notification systems. Based on the organizer's historical trends, estimates may be made about future behaviors as well.

In the example of embodiment 500, each parameter may be presented to the event organizer for feedback. Some embodiments may identify a subset of parameters that may be presented to an event organizer. For example, the event organizer's history may be used to identify a probable range of tolerance for a given parameter and may not present the parameter to the event organizer.

Once the parameters may be processed in block 518, the process may continue to add attendees in block 532.

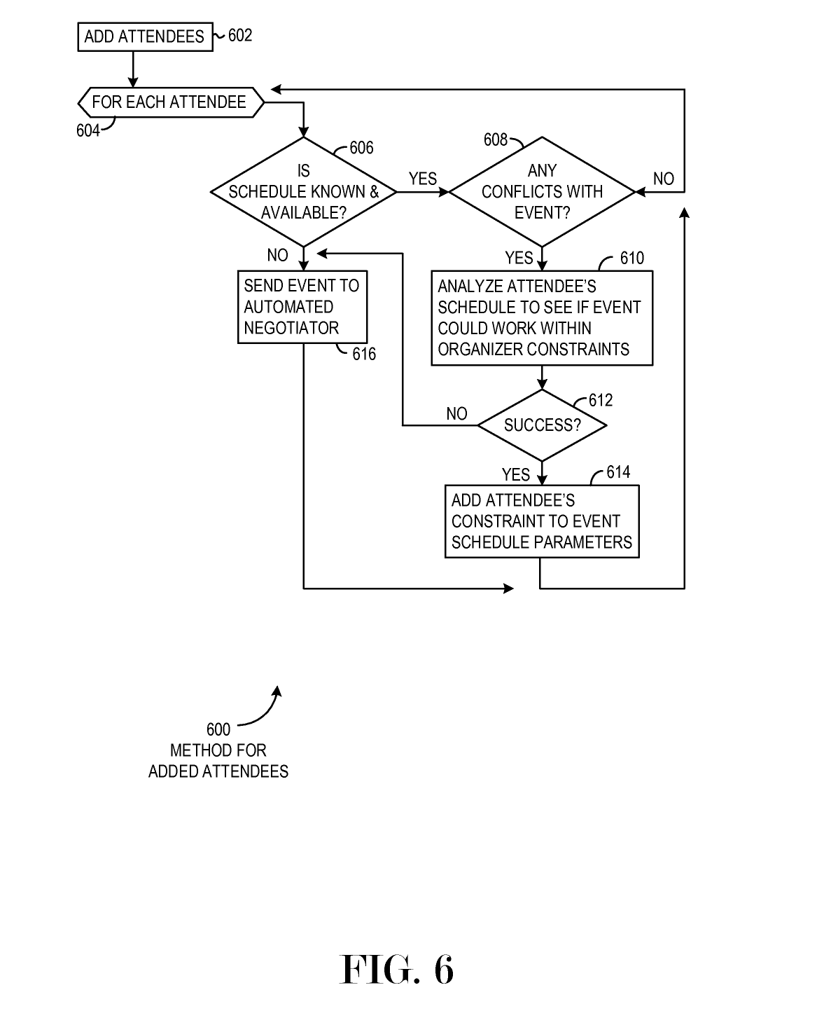

FIG. 6 is a flowchart illustration of an embodiment 600 showing a simplified example of steps that may be performed when adding attendees to an event.

Other embodiments may use different sequencing, additional or fewer steps, and different nomenclature or terminology to accomplish similar functions. In some embodiments, various operations, or sets of operations, may be performed in parallel with other operations, either in a synchronous or asynchronous manner. The steps selected here were chosen to illustrate some principles of operations in a simplified form.

Embodiment 600 may illustrate a process that may be performed as attendees may be added to an event by an event organizer. When an attendee may have a schedule that may be known to the system, some preliminary analysis of the attendee's availability for an event may be made. Such analysis may permit an event organizer to make changes to the event parameters prior to sending the event out to the automated negotiator.

Adding attendees may be done in block 602. For each added attendee in block 604, if the schedule is known and shows that the attendee may be available in block 606, and if there are no conflicts with the event in block 608, the process may loop back to block 604. In such a situation, the system may not detect any conflicts between the event description and any constraints that an attendee may have.

The schedule may be known and shows that the attendee may be available in block 606 when the attendee may use the same system as the event organizer for managing their schedules. In such a case, and when permission may be granted by the attendee, the system may be able to analyze the attendee's schedule automatically. In some cases, an attendee may grant permission to view only certain events or only certain types of data. In one version, an attendee may grant only available/not available status for their schedule but may not grant permission to view other parameters.

When the schedule may be known and available in block 606 but a conflict may exist in block 608, an analysis may be performed in block 610 to determine if the attendee would be available within the variations defined for the event. The variations may include time variations, location variations, attendee variations, or other parameters for the event. When a conflict still exists in block 612, the process may proceed to block 616 to send the event to the automated negotiator for that attendee.

When the analysis of block 610 shows that the intersection of the event organizer's constraints and the attendee's constrains yield an acceptable set of parameters for the event in block 612, the attendee's constraint may be added to the overall set of constraints for the event in block 614. The organizer's set of constraints may have been defined by the process of embodiment 500, and by adding the attendee's constraints, the set of constraints may define a narrower range of possibilities for the event. The new set of constraints may then be applied during the automated negotiation phase to find an optimized set of event parameters.

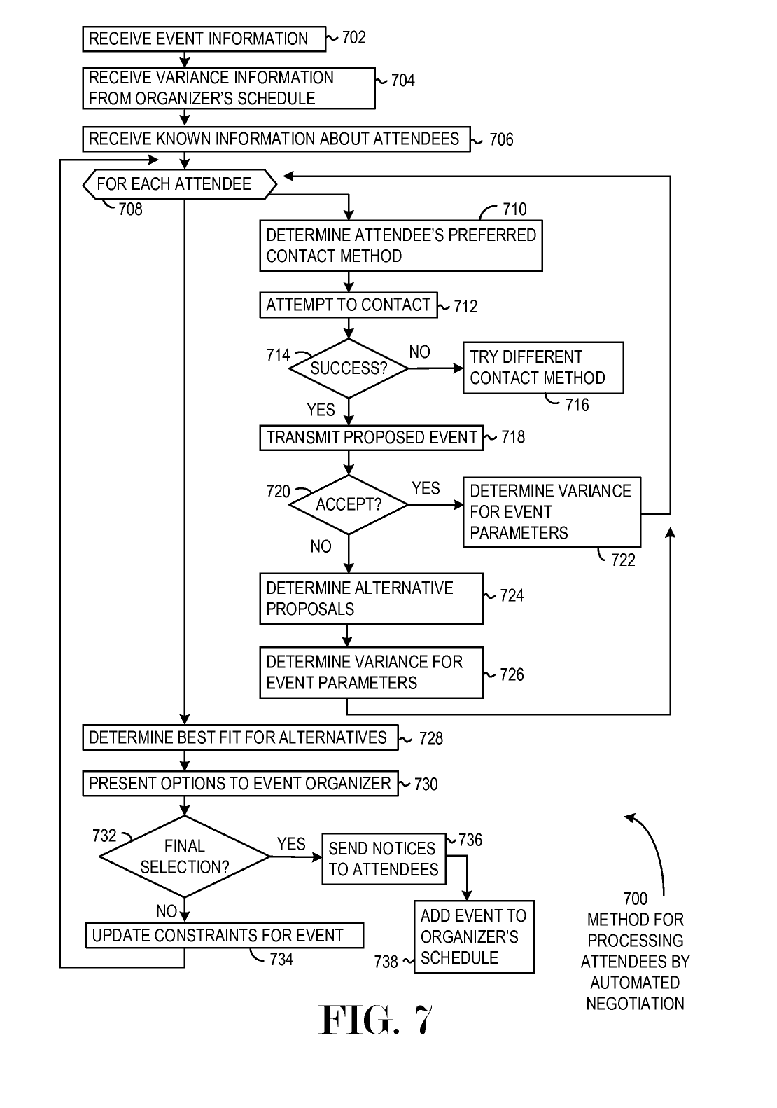

FIG. 7 is a flowchart illustration of an embodiment 700 showing a simplified example of steps that may be performed during an automated negotiation for scheduling an event.

Other embodiments may use different sequencing, additional or fewer steps, and different nomenclature or terminology to accomplish similar functions. In some embodiments, various operations or sets of operations may be performed in parallel with other operations, either in a synchronous or asynchronous manner. The steps selected here were chosen to illustrate some principles of operations in a simplified form.

Embodiment 700 may illustrate an automated negotiation that may be performed to schedule an event with multiple attendees.

Event information may be received in block 702. The event variance information may also be received in block 704. The event variance information may be a set of constraints for which an event may be possible. In many cases, the event variance information may include priorities, ranked lists of options, or other expressions of the variations. Any known information about the attendees may be received in block 706. In some cases, the only known information may be a telephone number, electronic mail address, or other method for contacting the attendee.

For each attendee in block 708, the attendee's preferred contact method may be determined in block 710. An attempt to contact the attendee may be made in block 712. When no success at contacting may be made in block 714, a different contact method may be tried in block 716.

For many attendees, contact may be made through text messaging, a computer-driven voice call, electronic mail, connections through social media, or other mechanisms.

A proposed event may be transmitted to the attendee in block 718. When the attendee may accept the event as presented in block 720, in some cases, an automated negotiator may ask for alternatives or determine the attendee's flexibility on certain parameters in block 722. Those parameters may be selected from the parameters for which the event organizer or other attendees have expressed little flexibility.

When the attendee does not accept the proposed event in block 720, an automated negotiator may solicit alternate proposals or present alternative proposals in block 724, and may also attempt to determine the attendee's flexibility on various parameters in block 726.

After collecting data from each of the attendees, a best fit set of alternatives may be determined in block 728 and presented to the event organizer in block 730. If the event organizer does not accept the alternatives in block 732, the constraints for the event may be changed by the event organizer in block 734 and the process may loop back to have the automated negotiator communicate with each attendee to gather additional information or alternatives.

When the event organizer determines the final selection in block 732, notices may be sent to the attendees in block 736 and the event may be added to the event organizer's schedule in block 738.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed by at least one computer processor, said method comprising:
receiving an event description;
receiving a plurality of attendees for said event;
for a first attendee of said plurality of attendees:
transmitting said event description to said first attendee;
receiving a counter offer for said event;
presenting said counter offer in an event organizer user interface;
receiving an approval for said counter offer from said event organizer user interface; and
transmitting an approval indicator to said first attendee.

2. The method of claim 1, said event description comprising a time frame, said counter offer comprising a proposed time frame.

3. The method of claim 1, said event description comprising a location, said counter offer comprising a proposed location.

4. The method of claim 1, said event description comprising an attendee list, said counter offer comprising a proposed change to said attendee list.

5. A method performed by at least one computer processor, said method comprising:
receiving an event description;
receiving a plurality of attendees for said event;
receiving a set of organizer constraints for said event;
for a first attendee of said plurality of attendees:
transmitting said event description to said first attendee;
receiving an attendee constraint;
evaluating said attendee constraint against said set of organizer constraints to determine a counter offer; and
transmitting said counter offer to said first attendee.

6. The method of claim 5 further comprising:
receiving a confirmation from said first attendee; and
adding said event modified by said counter offer to a schedule for said event organizer.

7. The method of claim 6, said counter offer being a change to said event description, said change being one of a group composed of:
a location;
a start time;
an end time;
a venue;
an agenda; and
an attendee list.

8. The method of claim 5, said event description being transmitted by a method being one of a group composed of:
text messaging;
automated voice interaction;
electronic messaging; and
messaging via a social network.

9. A system comprising:
at least one processor;
an event organizer interface operable on said at least one processor, said event organizer interface configured to:
receive an event description;
receive a set of organizer constraints related to said event description;
receive an attendee list; and
for each of said attendees on said attendee list, determine a communication medium;
an automated negotiator configured to:
transmit said event description to a first attendee using a first communication medium;
receive a first attendee constraint;
determine a counter offer based on said first attendee constraint and said set of organizer constraints; and
transmit an updated event description to said first attendee, said updated event description comprising said event description modified by said counter offer.

10. The system of claim 9 further comprising:
an interface to a scheduling system configured to:
add said updated event description to a calendar for said event organizer.

11. The system of claim 9, said automated negotiator further configured to:
transmit said updated event description to a second attendee;
receive a second attendee constraint;
determining that said first attendee constraint and said second attendee constraint are incompatible; and
presenting said first attendee constraint and said second attendee constraint in said event organizer interface.

12. The system of claim 11, said automated negotiator further configured to:
receive approval for said second attendee constraint;
update said updated event description to a second updated event description; and
transmit said second updated event description to said first attendee.

13. The system of claim 11, said automated negotiator further configured to:
receive approval for said first attendee constraint; and
transmit a communication to said second attendee regarding approval for said first constraint.

14. The system of claim 9, said set of organizer constraints being derived at least in part from analyzing an event organizer schedule.

15. The system of claim 14, said analyzing an event organizer schedule comprising determining an earliest and latest start time from said event organizer schedule.

16. The system of claim 15, said event organizer interface further configured to:
identify a second event on said event organizer schedule as a low priority event, said low priority event having a lower priority than said event.
